(19) United States
(12) Patent Application Publication
(10) Pub. No.: US 2021/0362391 A1
(43) Pub. Date: Nov. 25, 2021

(54) RESIN FILLER TUBE AND MANUFACTURING METHOD THEREOF

(71) Applicant: Sumitomo Riko Company Limited, Aichi (JP)

(72) Inventors: Makoto Shimojo, Aichi (JP); Atsuo Miyajima, Aichi (JP); Takayuki Kobayashi, Aichi (JP); Eunjin Park, Aichi (JP)

(73) Assignee: Sumitomo Riko Company Limited, Aichi (JP)

(21) Appl. No.: 17/314,005

(22) Filed: May 6, 2021

(30) Foreign Application Priority Data
May 19, 2020 (JP) 2020-087408

(51) Int. Cl. B29C 48/00; B29C 48/09; B29C 48/13; B29C 49/00; B29C 53/08; B29C 53/30

(52) U.S. Cl. CPC B29C 48/0018; B29C 48/09; B29C 48/13; B29L 2023/183; B29C 53/083; B29C 53/30; B29C 49/0021

(57) ABSTRACT

Provided are a resin filler tube capable of facilitating manufacture and ensuring rigidity in a bent tube portion, and a manufacturing method thereof. A resin filler tube connects an oil filling port and a fuel tank and includes straight tube portions and bent tube portions. The bent tube portions include a bellows-shaped bent inner portion in which hill portions and valley portions are continuous, and a bent outer portion which is formed by a non-bellows-shaped smooth surface. The valley portion of the bent inner portion has a linear outer peripheral surface parallel to a center line of the bent tube portions in a state in which the bent tube portions are in a straight tubular shape, and the linear outer peripheral surface of the valley portions is formed in an entire circumferential range in which the hill portions are formed.

### CROSS-REFERENCE TO RELATED APPLICATION

This application claims the priority benefit of Japan Application No. 2020-087408, filed on May 19, 2020. The entirety of the above-mentioned patent application is hereby incorporated by reference herein and made a part of this specification.

### BACKGROUND

### Technical Field

The disclosure relates to a resin filler tube and a manufacturing method thereof.

### Related Art

A resin filler tube (also referred to as a filler hose or a filler pipe) connects an oil filling port and a fuel tank in an automobile to flow fuel. Since the filler tube needs to be arranged so as not to interfere with other components, the filler tube generally includes a straight tube portion and a bent tube portion (also referred to as a bent portion).

In addition, the resin filler tube is assembled, for example, as follows. First, the oil filling port is attached to an end portion of the resin filler tube, and then the oil filling port which is attached to the resin filler tube is coupled to a body of the automobile. Here, when the oil filling port is coupled to the body of the automobile, an operator holds the resin filler tube because it is not easy to hold the oil filling port from the viewpoint of space. If the bent tube portion of the resin filler tube has low rigidity, the bent tube portion will bend when the oil filling port is coupled to the body of the automobile, and the oil filling port and the body of the automobile cannot be easily coupled. Therefore, the bent tube portion is bendable from the viewpoint of the shape freedom degree, but needs to have the rigidity for holding the shape from the viewpoint of workability for assembling the bent tube portion to the body of the automobile.

In addition, because the resin filler tube flows the fuel, a pressure loss becomes large due to existence of irregularities on an inner peripheral surface. That is, the fact that the bent tube portion is formed in a bellows shape causes the pressure loss to increase.

Therefore, it is known that instead of forming an entire circumference of the bent tube portion in a circumferential direction in a bellows shape as described in Patent literature 1, only the bent inner side is formed in a bellows shape, and the bent outer side is formed in a smooth shape, as described in Patent literature 2 and Patent literature 3. In addition, Patent literatures 4 to 7 describe that a part in the circumferential direction is formed in a bellows shape or an uneven shape, and the rest part in the circumferential direction is formed in a smooth shape.

### LITERATURE OF RELATED ART

### Patent Literature

[Patent literature 1] Japanese Patent Laid-open No. 2006-234131
[Patent literature 2] Japanese Patent Laid-open No. 2003-113986
[Patent literature 3] Japanese Patent Laid-open No. 2000-283348
[Patent literature 4] Japanese Patent Laid-open No. H11-291361
[Patent literature 5] Japanese Patent Laid-open No. 2001-191421
[Patent literature 6] Japanese Patent Laid-open No. 2020-41683
[Patent literature 7] Japanese Patent Laid-open No. S60-34172

As described above, the resin filler tube is required to be bendable from the viewpoint of the shape freedom degree, have rigidity for holding a shape from the viewpoint of assembling workability, and have a shape capable of reducing the pressure loss in the bent tube portion.

The tube described in Patent literature 2 is provided with a rib extending in a tube axis direction on the outer peripheral surface of the bent tube portion to ensure rigidity, and thus manufacture is not easy. The tubes described in Patent literature 3 and Patent literature 4 are not rigid enough.

The disclosure provides a resin filler tube capable of facilitating manufacture and ensuring rigidity in a bent tube portion, and provides a manufacturing method thereof.

### SUMMARY

(1. Resin Filler Tube)

The resin filler tube connects an oil filling port and a fuel tank and includes a straight tube portion and a bent tube portion, wherein the bent tube portion includes a bellows-shaped bent inner portion in which hill portions and valley portions are continuous, and a bent outer portion which is formed by a non-bellows-shaped smooth surface. The valley portion of the bent inner portion has a linear outer peripheral surface parallel to a center line of the bent tube portion in a state in which the bent tube portion is in a straight tubular shape, and the linear outer peripheral surface of the valley portion is formed in an entire circumferential range in which the hill portions are formed.

The bent tube portion is formed in a bellows shape on the bent inner side. Therefore, the resin filler tube is bendable in the bent tube portion, and has a shape freedom degree. In addition, in the bent tube portion, the bent outer portion is formed by a non-bellows-shaped smooth surface. Therefore, a pressure loss in a fuel flow can be reduced.

Furthermore, in the bent inner portion of the bent tube portion, the bellows-shaped valley portion has a linear outer peripheral surface. In other words, a valley bottom of the valley portion is not inclined and is formed flat in an axial cross section. If the valley portion does not have a linear outer peripheral surface and is inclined to the valley bottom of the valley portion, the bent tube portion is likely to bend toward the bent inner side. In this case, the bent tube portion is likely to deform into a state in which an angle of the bent inner side of the bent tube portion becomes smaller. That is, the rigidity of the bent tube portion is low. This generates a problem from the viewpoint of workability during assembling to a body of an automobile. However, because the valley bottom of the valley portion has a linear outer peripheral surface, the bent tube portion becomes difficult to bend. That is, the rigidity of the bent tube portion is increased. As a result, the workability when the resin filler tube is assembled to the body of the automobile is improved.

In addition, as described above, in order to ensure the rigidity, the bellows-shaped valley portion has a linear outer peripheral surface in the bent inner portion of the bent tube portion. This shape can be easily manufactured by the molding of the bellows shape.

(2. Manufacturing Method of Resin Filler Tube)

In a manufacturing method of a resin filler tube, a straight tubular material is extrusion-molded using an extrusion machine, the straight tube portion and the bent tube portion being straight tubular shaped are formed by using a corrugation molding machine continuously arranged from the extrusion machine to process the straight tubular material, and the bent tube portion being bent is molded by performing a bending process on the bent tube portion being straight tubular shaped. The resin filler tube manufactured by the manufacturing method exhibits the effect described above.

### BRIEF DESCRIPTION OF THE DRAWINGS

FIG. 1 is a diagram of a fuel line.

FIG. 2 is a partial diagram of a resin filler tube, which shows a state in which a bent tube portion is in a straight tubular shape (a state before a bending process).

FIG. 3 is an axial cross-sectional view of the resin filler tube shown in FIG. 2.

FIG. 4 is a cross-sectional view along line IV-IV of FIG. 3.

FIG. 5 is a cross-sectional view along line V-V of FIG. 3.

FIG. 6 is a cross-sectional view along line VI-VI of FIG. 3.

FIG. 7 is a flowchart showing a manufacturing method of the resin filler tube.

FIG. 8 is a diagram showing an extrusion machine, a corrugation molding machine, and a cutting machine which are a part of a manufacturing apparatus of the resin filler tube.

FIG. 9 is a cross-sectional view along line IX-IX of FIG. 8.

### DESCRIPTION OF THE EMBODIMENTS

(1. Configuration of Fuel Line 1)

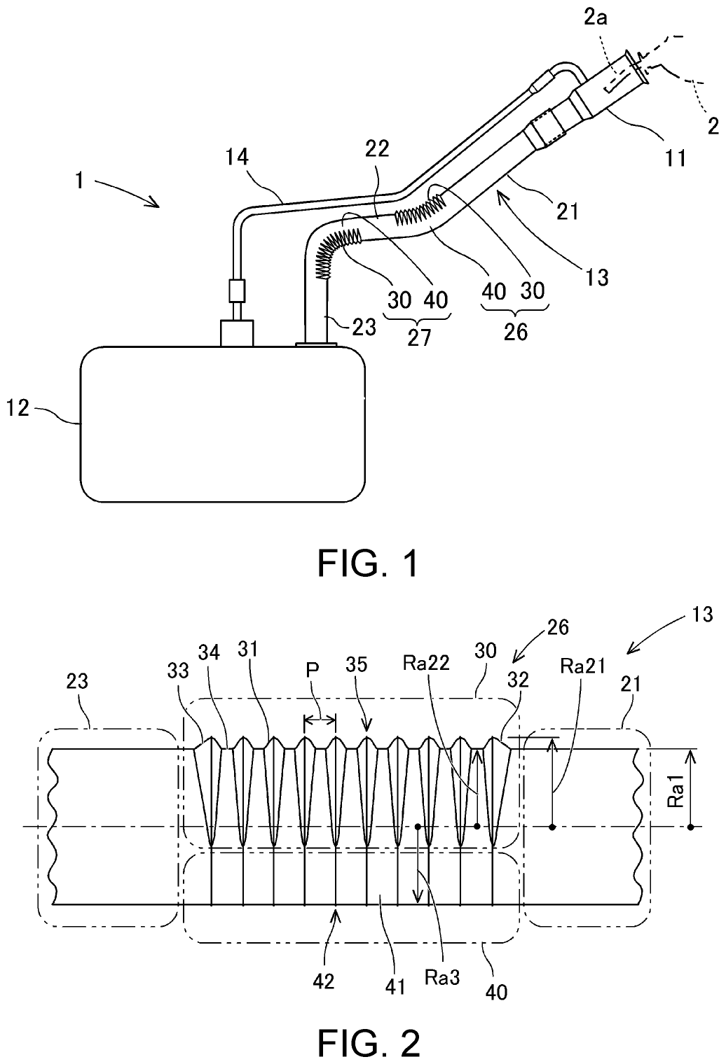

The configuration of a fuel line 1 is described with reference to FIG. 1. The fuel line 1 is a line from an oil filling port 11 to an internal combustion engine (not shown) in an automobile. However, in the example, a section from the oil filling port 11 to a fuel tank 12, which is a part of the fuel line 1, is described.

The fuel line 1 includes the oil filling port 11, the fuel tank 12, a resin filler tube 13, and a breather tube 14. The oil filling port 11 is arranged near an outer surface of the body of the automobile, into which a nozzle 2a of an oil filling gun 2 can be inserted. The oil filling port 11 includes a type in which an oil filling gap (not shown) is attached and a type in which the oil filling gap is not attached. The oil filling port 11 is coupled (engaged) to the body of the automobile. The fuel tank 12 stores liquid fuel such as gasoline or the like. The liquid fuel stored in the fuel tank 12 is supplied to the internal combustion engine (not shown), and is used to drive the internal combustion engine.

The resin filler tube 13 is formed by a long pipe (also referred to as a hose) made of resin. Although one resin filler tube 13 is shown in FIG. 1, a configuration may also be adopted in which a plurality of resin filler tubes 13 and joints (not shown) connecting the tubes 13 are included.

The resin filler tube 13 connects the oil filling port 11 and the fuel tank 12, and flows the supplied liquid fuel in a forward direction. The nozzle 2a of the oil filling gun 2 is inserted into the oil filling port 11, the liquid fuel is supplied from the nozzle 2a, and thereby the liquid fuel passes through the resin filler tube 13 and is stored in the fuel tank 12. Here, when the fuel tank 12 is full of the liquid fuel, the liquid fuel is stored in the resin filler tube 13 and comes into contact with a front end of the nozzle 2a of the oil filling gun 2, and thereby the supply of the liquid fuel by the nozzle 2a is automatically stopped (an automatic stop function).

The breather tube 14 is formed by a long pipe (also referred to as a hose) made of resin. The breather tube 14 connects the fuel tank 12 and the oil filling port 11. When the liquid fuel is supplied to the fuel tank 12 via the resin filler tube 13, the breather tube 14 discharges fuel vapour in the fuel tank 12 to the outside of the fuel tank 12.

In addition, during the fuel filling, when the fuel tank 12 is full and the automatic stop function is actuated, the liquid fuel from the fuel tank 12 refluxes to the oil filling port 11 via the breather tube 14. In this way, the breather tube 14 flows the fuel vapor during the fuel filling and the liquid reflux fuel during the automatic stop.

(2. Assembly of Resin Filler Tube 13)

Work of assembling the resin filler tube 13 to the body of the automobile is performed, for example, as follows. First, the oil filling port 11 is attached to an end portion of the resin filler tube 13. Then, the oil filling port 11 attached to the resin filler tube 13 is coupled to the body of the automobile.

Here, when the oil filling port 11 is coupled to the body of the automobile, an operator holds the resin filler tube 13 because it is not easy to hold the oil filling port 11 from the viewpoint of space. In particular, the operator may have to hold a site on the opposite side of the oil filling port 11 instead of the bent tube portion of the resin filler tube. In addition, in order to couple the oil filling port 11 to the body of the automobile, the operator pushes in the oil filling port 11 and the resin filler tube 13 while holding the site. Then, the oil filling port 11 is coupled to the body of the automobile.

(3. Overall Configuration of Resin Filler Tube 13)

The configuration of the resin filler tube 13 is described with reference to FIG. 1. As described above, the resin filler tube 13 connects the oil filling port 11 and the fuel tank 12. Because various components of the automobile are present between the oil filling port 11 and the fuel tank 12, the resin filler tube 13 is arranged among these components.

Therefore, the resin filler tube 13 has at least one bendable site. In the example, the resin filler tube 13 includes three straight tube portions 21, 22 and 23, and two bent tube portions 26 and 27. However, the resin filler tube 13 may be configured to include at least two straight tube portions 21, 22, or 23, and at least one bent tube portion 26 or 27. Evidently, the resin filler tube 13 may also be configured to include three or more bent tube portions 26 and 27.

In detail, the resin filler tube 13 in the example includes a first straight tube portion 21 connected to the oil filling port 11, a second straight tube portion 22 connected to the fuel tank 12, and a third straight tube portion 23 located between the first straight tube portion 21 and the second straight tube portion 22. The straight tube portions 21, 22 and 23 are linear tubes.

The resin filler tube 13 includes a first bent tube portion 26 connecting the first straight tube portion 21 and the third straight tube portion 23, and a second bent tube portion 27 connecting the second straight tube portion 22 and the third straight tube portion 23. The bent tube portions 26 and 27 configure the bendable sites. In particular, the bent tube portions 26 and 27 are formed in a bellows shape in a part of a circumferential direction. By being formed in a bellows shape, the bent tube portions 26 and 27 are formed in a shape which is easier to bend and deform than the straight tube portions 21, 22 and 23.

(4. Detailed Configuration of Resin Filler Tube 13)

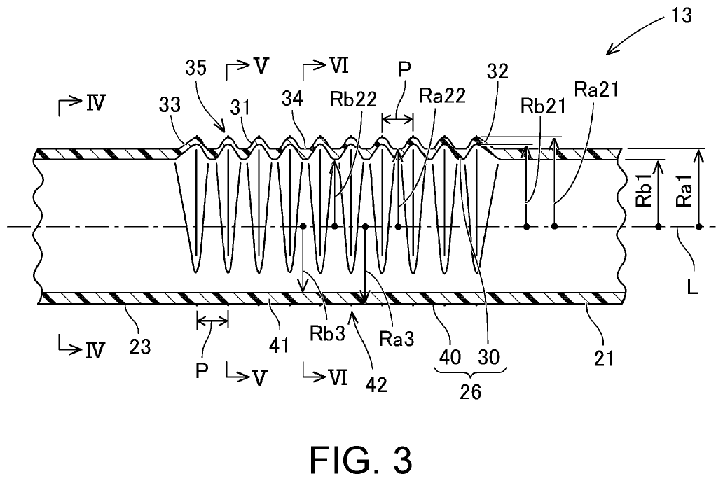

The detailed configuration of the resin filler tube 13 is described with reference to FIGS. 2 to 5. Here, FIG. 2 and FIG. 3 show a state in which the entire resin filler tube 13 is in a straight tubular shape. That is, FIG. 2 and FIG. 3 show the resin filler tube 13 in a state before the bent tube portions 26 and 27 are subjected to a bending process, that is, the bent tube portions 26 and 27 are in the straight tubular shape.

In addition, a part of the first straight tube portion 21, the first bent tube portion 26, and the third straight tube portion 23 in the resin filler tube 13 is described below. Moreover, the second straight tube portion 22 is configured substantially the same as the first straight tube portion 21, and the second bent tube portion 27 is configured substantially the same as the first bent tube portion 26.

As shown in FIG. 2 and FIG. 3, the first straight tube portion 21 is formed in a cylindrical shape with a center line L as a center. The first straight tube portion 21 is also formed in a cylindrical shape when assembled to the automobile as shown in FIG. 1. As shown in FIG. 2 and FIG. 3, an outer peripheral surface of the first straight tube portion 21 is a circle having a radius Ra1 with the center line L as a center. As shown in FIG. 3, an inner peripheral surface of the first straight tube portion 21 is a circle having a radius Rb1 with the center line L as a center. That is, a thickness of the first straight tube portion 21 is (Ra1-Rb1). Here, in the example, a diameter of the outer peripheral surface of the first straight tube portion 21 (2×Ra1) is set to 20 mm or more and 40 mm or less.

The third straight tube portion 23 is formed in the same shape as the first straight tube portion 21. That is, the third straight tube portion 23 is formed in a cylindrical shape with the center line L as a center. The third straight tube portion 23 is also formed in a cylindrical shape when assembled to the automobile as shown in FIG. 1. An outer peripheral surface of the third straight tube portion 23 is a circle having a radius Ra1 with the center line L as a center. In addition, an inner peripheral surface of the third straight tube portion 23 is a circle having a radius Rb1 with the center line L as a center. In addition, a diameter of the outer peripheral surface of the third straight tube portion 23 (2×Ra1) is set to 20 mm or more and 40 mm or less.

The first bent tube portion 26 is located between the first straight tube portion 21 and the third straight tube portion 23, and is connected with the first straight tube portion 21 and the third straight tube portion 23. The first bent tube portion 26 is in the straight tubular shape in FIG. 2 and FIG. 3, but the first bent tube portion 26 is in a bent state when assembled to the automobile as shown in FIG. 1.

The first bent tube portion 26 includes a bent inner portion 30 and a bent outer portion 40 in the bent state as shown in FIG. 1. The bent inner portion 30 includes a site having a minimum forming angle, and the bent outer portion 40 includes a site having a maximum forming angle. In FIG. 2 and FIG. 3, the bent inner portion 30 is located on an upper side of the diagram, and the bent outer portion 40 is located on a lower side of the diagram.

The bent inner portion 30 is formed in a bellows shape in which hill portions 31, 32 and 33 and valley portions 34 are continuous. Because the bent inner portion 30 is bellows-shaped, the bent inner portion 30 is bendable. In the example, the bent inner portion 30 includes hill portions 31 in the middle in an axial direction, and hill portions 32 and 33 at both ends in the axial direction. In particular, the bent inner portion 30 includes a plurality of hill portions 31 in the middle in the axial direction.

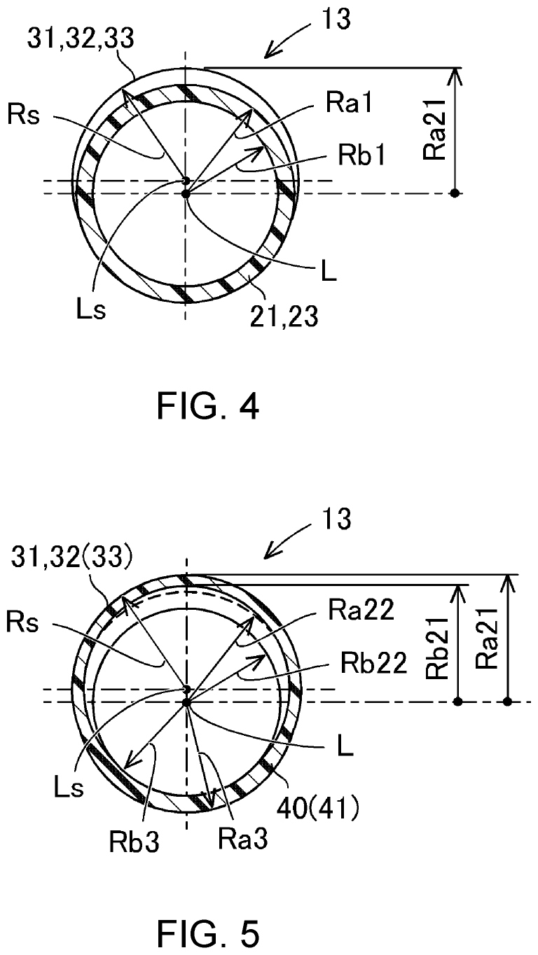

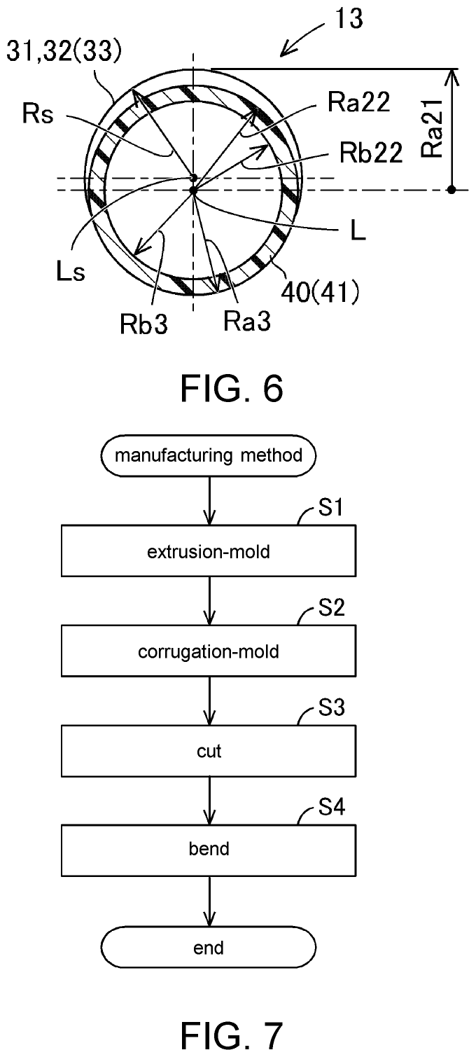

As shown in FIG. 2 and FIG. 3, an outer peripheral surface of each of the hill portions 31, 32 and 33 is formed in a shape having a vertex on radial outer side and having inclined surfaces on two sides in the axial direction. As shown in FIG. 3, an inner peripheral surface of each of the hill portions 31, 32 and 33 is formed in a shape obtained by transferring the outer peripheral surface. Furthermore, as shown in FIGS. 4 to 6, the hill portions 31, 32 and 33 are not formed in the entire circumference in the circumferential direction. As shown in FIG. 4 and FIG. 6, the vertices of the outer peripheral surfaces of the hill portions 31, 32 and 33 are set in a range of, for example, 160° or more and 320° or less in the circumferential direction. In addition, as shown in FIG. 5, positions corresponding to vertices of the inner peripheral surfaces of the hill portions 31, 32 and 33 are set in the range substantially equal to the vertices of the outer peripheral surfaces in the circumferential direction. Therefore, the radial protrusion amount of the hill portions 31, 32 and 33 is the largest at the center of the formation angle range, and becomes smaller toward the ends of the formation angle range. However, the formation angle range of the hill portions 31, 32 and 33 is not limited to the range described above, and can be an arbitrary range.

In addition, as shown in FIG. 4, the vertices of the outer peripheral surfaces of the hill portions 31, 32 and 33 are located on an arc with a line Ls as a center, the line Ls being eccentric from the center line L of the first straight tube portion 21. That is, the center Ls of the vertices of the outer peripheral surfaces of the hill portions 31, 32 and 33 is eccentric with respect to the center of the first straight tube portion 21. In addition, a curve connecting the vertices of the outer peripheral surfaces of the hill portions 31, 32 and 33 is an arc having a radius Rs with the center Ls as the center.

Furthermore, a vertex farthest from the center line L (a farthest vertex) among the vertices of the outer peripheral surfaces of the hill portions 31, 32 and 33 is located at a position with a distance Ra21 from the center line L. The distance Ra21 of the farthest vertex is larger than the radius Ra1 of the outer peripheral surface of the first straight tube portion 21. In addition, among the positions corresponding to the vertices of the inner peripheral surfaces of the hill portions 31, 32 and 33, a point farthest from the center line L (a farthest inner peripheral point) is located at a position with a distance Rb21 from the center line L. The distance Rb21 of the farthest inner peripheral point is larger than the radius Rb1 of the inner peripheral surface of the first straight tube portion 21. Furthermore, in the example, the distance Rb21 of the farthest inner peripheral point is set to be equal to or greater than the radius Ra1 of the outer peripheral surface of the first straight tube portion 21. However, the distance Rb21 of the farthest inner peripheral point may also be set to be equal to or less than the radius Ra1. Moreover, the farthest vertex and the farthest inner peripheral point are located at the center of the formation angle range of the hill portions 31, 32 and 33.

In the hill portion 31 in the middle in the axial direction, inclination angles of the inclined surfaces on two sides in the axial direction are the same. The inclination angle of the hill portion 31 in the middle in the axial direction is set to, for example, 40° or more and 80° or less. However, in the hill portion 31 in the middle in the axial direction, the inclination angles of the inclined surfaces on two sides in the axial direction may also be different.

In the hill portions 32 and 33 at both ends in the axial direction, the inclination angles of the inclined surfaces on two sides in the axial direction are different. In the hill portions 32 and 33 at both ends in the axial direction, the inclined surfaces on the hill portion 31 side in the middle in the axial direction have the same inclination angle as the inclined surfaces of the hill portion 31 in the middle in the axial direction. On the other hand, in the hill portions 32 and 33 at both ends in the axial direction, the inclined surfaces on the axial outer side have an inclination angle smaller than the inclined surfaces of the hill portion 31 in the middle in the axial direction. The reason is that, in the state in which the bent tube portions 26 and 27 are bent as shown in FIG. 1, the hill portions 32 and 33 at both ends in the axial direction become difficult to buckle. That is, by setting the inclination angle as described above, the hill portions 32 and 33 at both ends in the axial direction have rigidity.

In addition, pitches P of adjacent hill portions 31, 32 and 33 are set to be the same. In the example, the pitch P of the hill portions 31, 32 and 33 is set to a predetermined value of 4 mm or more and 7 mm or less.

The valley portions 34 are located among adjacent hill portions 31, 32 and 33. As shown in FIG. 2 and FIG. 3, the valley portion 34 has a linear outer peripheral surface parallel to a center line of the bent tube portions 26 and 27 (the center line L of the first straight tube portion 21) in the state in which the bent tube portions 26 and 27 are in the straight tubular shape.

The linear outer peripheral surface of the valley portion 34 is an arc surface with the center line L of the first straight tube portion 21 as a center. The linear outer peripheral surface of the valley portion 34 is formed in an entire circumferential range in which the hill portions 31, 32 and 33 are formed. A radius Ra22 of the linear outer peripheral surface of the valley portion 34 is set to be equal to or greater than the radius Ra1 of the outer peripheral surface of the first straight tube portion 21. In particular, in the example, the radius Ra22 of the linear outer peripheral surface of the valley portion 34 is set to be the same as the radius Ra1 of the outer peripheral surface of the first straight tube portion 21.

In addition, an axial width of the valley portion 34 is the smallest at the center of the formation angle range, and is increased toward the ends of the formation angle range. For example, the minimum axial width of the valley portion 34 is set to ⅕ or more and ½ or less of the pitch P of the hill portions 31, 32 and 33. In the example, the minimum axial width of the valley portion 34 is set to 0.8 mm or more and 3.5 mm or less.

A radius Rb22 of an inner peripheral surface of the valley portion 34 is set to be equal to or greater than the radius Rb1 of the inner peripheral surface of the first straight tube portion 21. Therefore, in the bent inner portion 30 of the bent tube portions 26 and 27, as compared with the first straight tube portion 21, a decrease of a flow path cross-sectional area can be suppressed. That is, a pressure loss due to the decrease of the flow path cross-sectional area can be suppressed.

The inner peripheral surface of the valley portion 34 has the smallest diameter at the center in the axial direction, and becomes larger toward both ends in the axial direction. The reason is that the resin filler tube 13 is molded by an extrusion machine and a corrugation molding machine. However, the inner peripheral surface of the valley portion 34 may have a linear inner peripheral surface parallel to the center line of the bent tube portions 26 and 27 (the center line L of the first straight tube portion 21). In this case, the radius Rb22 of the linear inner peripheral surface of the valley portion 34 may be set to be equal to or greater than the radius Rb1 of the inner peripheral surface of the first straight tube portion 21. In particular, the radius Rb22 of the linear inner peripheral surface of the valley portion 34 may be set to be the same as the radius Rb1 of the inner peripheral surface of the first straight tube portion 21.

The bent inner portion 30 further includes ribs 35. The ribs 35 are located in an entire circumferential range at the vertices of each of the hill portions 31, 32 and 33 on an outer peripheral surface of the bent inner portion 30. The height of the ribs 35 is lower than that of the hill portions 31, 32 and 33. The ribs 35 exhibit the effect of increasing the rigidity of the hill portions 31, 32 and 33.

The bent outer portion 40 is formed by a non-bellows-shaped smooth surface. Here, the bellows shape is a shape in which an outer peripheral surface is formed in an uneven shape in the axial direction and an inner peripheral surface is formed in an uneven shape obtained by transferring the outer peripheral surface. On the other hand, the non-bellows-shaped smooth surface has a shape in which the outer peripheral surface and the inner peripheral surface do not have irregularities in the axial direction. The non-bellows-shaped smooth surface is not limited to the case in which the surface is linear in the axial direction, and includes a case in which the surface has a curved shape. Specifically, the bent outer portion 40 has a curved convex outer peripheral surface and a curved concave inner peripheral surface in the axial direction.

In the state in which the bent tube portion 26 is in a straight tubular shape, the bent outer portion 40 is in a cylindrical shape. Here, the bent outer portion 40 includes a main body 41 and ribs 42. The main body 41 of the bent outer portion 40 has a cylindrical outer peripheral surface and a cylindrical inner peripheral surface in the state in which the bent tube portion 26 is in a straight tubular shape. A radius of the cylindrical outer peripheral surface in the main body 41 of the bent outer portion 40 is Ra3, and a radius of the cylindrical inner peripheral surface is Rb3.

Besides, the radius Ra3 of the cylindrical outer peripheral surface of the main body 41 is equal to or greater than the radius Ra1 of the outer peripheral surface of the first straight tube portion 21. In the example, the radius Ra3 of the cylindrical outer peripheral surface of the main body 41 is the same as the radius Ra1 of the outer peripheral surface of the first straight tube portion 21. In addition, the radius Rb3 of the cylindrical inner peripheral surface of the main body 41 is equal to or greater than the radius Rb1 of the inner peripheral surface of the first straight tube portion 21. In the example, the radius Rb3 of the cylindrical inner peripheral surface of the main body 41 is the same as the radius Rb1 of the inner peripheral surface of the first straight tube portion 21. Therefore, in the bent outer portion 40 of the bent tube portions 26 and 27, as compared with the first straight tube portion 21, the decrease of the flow path cross-sectional area can be suppressed. That is, the pressure loss due to the decrease of the flow path cross-sectional area can be suppressed.

Here, in the state in which the bent tube portions 26 and 27 are in a straight tubular shape, a cylindrical outer peripheral surface having a single outer diameter (Ra22, Ra3) is formed by the linear outer peripheral surface of the valley portion 34 and the outer peripheral surface of the main body 41 of the bent outer portion 40. Furthermore, the cylindrical outer peripheral surface has an outer diameter the same as the outer peripheral surface of the first straight tube portion 21.

In the case, which is described later, where the extrusion machine and the corrugation molding machine are used to mold, inner diameters can be made the same by making the outer diameters the same. That is, the radii of the inner peripheral surfaces of the first straight tube portion 21, the valley portion 34, and the bent outer portion 40 can be made to be about the same. As a result, the pressure loss due to the decrease of the flow path cross-sectional area can be suppressed.

The ribs 42 are continuously formed from the ribs 35 of the bent inner portion 30. That is, ribs over the entire circumference in the circumferential direction are formed by the ribs 35 and 42. That is, the bent tube portions 26 and 27 include the ribs 35 and 42, whose heights are lower than that of the hill portions 31, 32 and 33, over the entire circumference in the circumferential direction at the axial positions of the vertices of each of the hill portions 31, 32 and 33 on the outer peripheral surface of the bent tube portions 26 and 27.

(5. Effect of Bent Tube Portions 26 and 27)

The bent tube portions 26 and 27 are formed in a bellows shape on the bent inner side. Therefore, the resin filler tube 13 can be bent at the bent tube portions 26 and 27, and has a shape freedom degree. In addition, the bent outer portion 40 is formed by a non-bellows-shaped smooth surface in the bent tube portions 26 and 27. Therefore, the pressure loss in the fuel flow can be reduced.

Furthermore, in the bent inner portion 30 of the bent tube portions 26 and 27, the bellows-shaped valley portion 34 has the linear outer peripheral surface. In other words, the valley bottom of the valley portion 34 is not inclined and is formed flat in an axial cross section. If the valley portion 34 does not have a linear outer peripheral surface and is inclined to the valley bottom of the valley portion 34, the bent tube portions 26 and 27 are likely to bend toward the bent inner side. In this case, the bent tube portions 26 and 27 are likely to deform into a state in which the angle of the bent inner side of the bent tube portions 26 and 27 becomes smaller. That is, the rigidity of the bent tube portions 26 and 27 is low. This generates a problem from the viewpoint of workability during assembling to the body of the automobile. However, because the valley bottom of the valley portion 34 has the linear outer peripheral surface, the bent tube portions 26 and 27 become difficult to bend. That is, the rigidity of the bent tube portions 26 and 27 is increased. As a result, the workability when the resin filler tube 13 is assembled to the body of the automobile is improved.

In addition, as described above, in order to ensure the rigidity, the bellows-shaped valley portion 34 has the linear outer peripheral surface in the bent inner portion 30 of the bent tube portions 26 and 27. This shape can be easily manufactured by the molding of the bellows shape.

(6. Manufacturing Method of Resin Filler Tube 13)

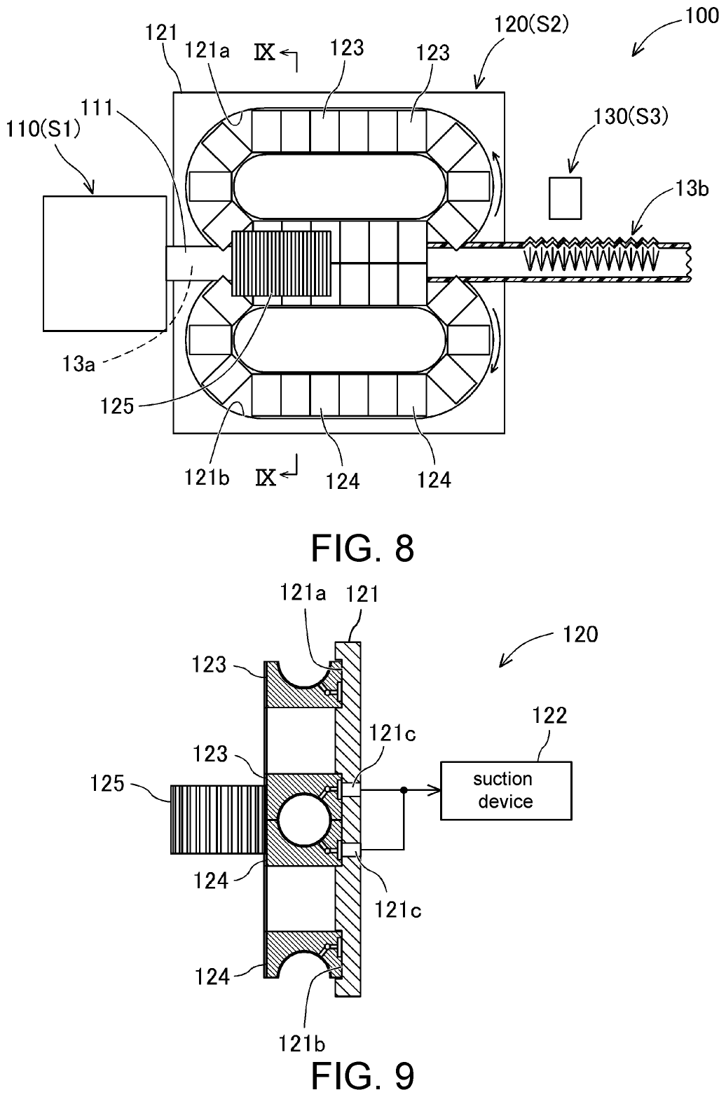

A manufacturing method of the resin filler tube 13 is described with reference to FIG. 7. In addition, a manufacturing apparatus 100 of the resin filler tube 13 is described with reference to FIG. 8 and FIG. 9.

As shown in FIG. 7, a straight tubular material 13a is extrusion-molded using an extrusion machine 110 shown in FIG. 8 and FIG. 9 (Step S1). The extrusion machine 110 extrudes the straight tubular material 13a at a prescribed speed. Moreover, the straight tubular material 13a has a known multi-layer structure, and is formed in a cylindrical shape having the same inner diameter and the same outer diameter ranging over the axial direction.

As shown in FIG. 8, a corrugation molding machine 120 is continuously arranged from the extrusion machine 110. Therefore, by using the corrugation molding machine 120 to process the straight tubular material 13a, the straight tube portions 21, 22 and 23 and the bent tube portions 26 and 27 being straight tubular shaped are formed (Step S2).

The corrugation molding machine 120 shapes the straight tubular material 13a extruded from a nozzle 111 of the extrusion machine 110 into a shape following an inner peripheral surface of a plurality of split molds 123 and 124 by attracting the straight tubular material 13a to the inner peripheral surface of the plurality of split molds 123 and 124. The corrugation molding machine 120 can be mainly applied to a site which changes the shape of the straight tubular material 13a extrusion-molded by the extrusion machine 110. That is, the corrugation molding machine 120 performs the molding of the bellows-shaped bent inner portion 30.

As shown in FIG. 8 and FIG. 9, the corrugation molding machine 120 includes a guide base 121, a suction device 122, the plurality of split molds 123 and 124, and a drive gear 125. A first guide groove 121a which is elliptical and a second guide groove 121b which has the same shape and is adjacent to the first guide groove 121a are formed on an upper surface of the guide base 121. Furthermore, communication holes 121c which communicate the first guide groove 121a and the second guide groove 121b are formed at the guide base 121. The suction device 122 is connected to the communication holes 121c of the guide base 121, and sucks air in the space communicated with the communication holes 121c.

A plurality of first split molds 123 are molds for forming one part of the resin filler tube 13 cut into two parts in the axial direction. The plurality of first split molds 123 sequentially move along the upper side of the first guide groove 121a of the guide base 121. That is, half of the resin filler tube 13 is formed by sequentially moving each of the plurality of first split molds 123. Here, rack teeth are formed on an upper surface on each of the plurality of first split molds 123.

In addition, a plurality of second split molds 124 are molds for forming the other part of the resin filler tube 13 cut in the axial direction. The plurality of second split molds 124 sequentially move along the upper side of the second guide groove 121b of the guide base 121. That is, the other half of the resin filler tube 13 is formed by sequentially moving each of the plurality of second split molds 124. Here, rack teeth are formed on an upper surface on each of the plurality of second split molds 124.

The first split mold 123 and the second split mold 124 have shaping surfaces corresponding to the hill portions 31, 32 and 33 and the valley portion 34 in the bent inner portion 30. Furthermore, the first split mold 123 and the second split mold 124 have slits corresponding to the ribs 35 and 42. The slit communicates with the communication hole 121c and functions as a suction site.

The drive gear 125 is a pinion gear that moves the plurality of first split molds 123 and the plurality of second split molds 124. The drive gear 125 is arranged on the extrusion machine 110 side of the mold pairs in which the plurality of first split molds 123 and the plurality of second split molds 124 are combined. Besides, the drive gear 125 meshes with the first split mold 123 and the second split mold 124 located at the site, and the plurality of first split molds 123 and the plurality of second split molds 124 are sequentially moved by the rotational driving of the drive gear 125.

As shown in FIG. 8, a cutting machine 130 is arranged on an output side of the corrugation molding machine 120. A straight tubular material 13b output from the corrugation molding machine 120 has a shape in which a plurality of resin filler tubes 13 are continuous in the axial direction. Therefore, the cutting machine 130 cuts the straight tubular material 13b, which is continuous and is shaped by the corrugation molding machine 120, to a predetermined length (Step S3).

Then, the bent tube portions 26 and 27 being bent are molded by performing the bending process on the bent tube portions 26 and 27 being straight tubular shaped in a desired angle and a desired direction using a bending machine (not shown) (Step S4). In this way, the resin filler tube 13 is completed, which includes the straight tube portions 21, 22 and 23, and the bent tube portions 26 and 27 being bent. Moreover, the resin filler tube 13 is coupled to the body of the automobile after the oil filling port 11 (shown in FIG. 1) is attached.

What is claimed is:

1. A resin filler tube, which connects an oil filling port and a fuel tank and comprises a straight tube portion and a bent tube portion, wherein
the bent tube portion comprises:
a bellows-shaped bent inner portion in which hill portions and valley portions are continuous, and
a bent outer portion which is formed by a non-bellows-shaped smooth surface,
the valley portions of the bent inner portion have a linear outer peripheral surface parallel to a center line of the bent tube portion in a state in which the bent tube portion is in a straight tubular shape, and
the linear outer peripheral surface of the valley portions is formed in an entire circumferential range in which the hill portions are formed.

2. The resin filler tube according to claim 1, wherein in the state in which the bent tube portion is in a straight tubular shape, a cylindrical outer peripheral surface having a single outer diameter is formed by the linear outer peripheral surface of the valley portions and an outer peripheral surface of the bent outer portion.

3. The resin filler tube according to claim 1, wherein when the straight tube portion and the bent tube portion are in a straight tubular shape and a center line L of the straight tube portion is set as a center, a radius Rb2 of an inner peripheral surface of the valley portions of the bent inner portion is set to be equal to or greater than a radius Rb1 of an inner peripheral surface of the straight tube portion.

4. The resin filler tube according to claim 3, wherein a radius Ra2 of an outer peripheral surface of the valley portions of the bent inner portion is set to be equal to or greater than a radius Ra1 of an outer peripheral surface of the straight tube portion.

5. The resin filler tube according to claim 1, wherein the resin filler tube comprises a plurality of bent tube portions.

6. The resin filler tube according to claim 3, wherein a center of vertices of the hill portions of the bent inner portion is eccentric with respect to the center of the straight tube portion.

7. The resin filler tube according to claim 1, wherein a diameter of an outer peripheral surface of the straight tube portion is set to 20 mm or more and 40 mm or less, and
a pitch of the adjacent hill portions of the bent inner portion is set to a predetermined value of 4 mm or more and 7 mm or less.

8. The resin filler tube according to claim 1, wherein the bent tube portion comprises ribs, whose heights are lower than that of the hill portions, over an entire circumference in a circumferential direction at axial positions of the vertices of each of the hill portions on an outer peripheral surface of the bent tube portion.

9. The resin filler tube according to claim 1, wherein inclination angles of the hill portions at both ends in an axial direction are smaller than inclination angles of the hill portions in the middle in the axial direction.

10. A manufacturing method of a resin filler tube, which is a method for manufacturing the resin filler tube according to claim 1, wherein
a straight tubular material is extrusion-molded using an extrusion machine,
the straight tube portion and the bent tube portion being straight tubular shaped are formed by using a corrugation molding machine continuously arranged from the extrusion machine to process the straight tubular material, and
the bent tube portion being bent is molded by performing a bending process on the bent tube portion being straight tubular shaped.
